(19) United States
(12) Patent Application Publication
(10) Pub. No.: US 2017/0324787 A1
(43) Pub. Date: Nov. 9, 2017

(54) HANDLING SUPPLEMENTARY SERVICES

(71) Applicant: Telefonaktiebolaget LM Ericsson (publ), Stockholm (SE)

(72) Inventor: Anders WIDEBRANT, Lund (SE)

(73) Assignee: Telefonaktiebolaget LM Ericsson (publ), Stockholm (SE)

(21) Appl. No.: 15/517,949

(22) PCT Filed: Oct. 9, 2014
(86) PCT No.: PCT/EP2014/071598

§ 371 Date: Apr. 7, 2017

(51) Int. Cl. H04L 29/06; H04W 4/16

(52) U.S. Cl. CPC H04L 65/1096; H04W 4/16; H04L 29/06; H04L 65/1006

(57) ABSTRACT

A SIP-based method for supplementary services configuration is extended by the introduction of means for a network to service supplementary services interrogation requests from a UE by responding to a SIP INVITE sent by the UE. The response may be a SIP message and include, e.g., in the SIP message body a machine-readable representation of the interrogated service's current configuration.

### TECHNICAL FIELD

Embodiments herein relate to a wireless communication system, and more specifically to handling supplementary services information.

### BACKGROUND

Wireless communication systems, i.e. systems that provide communication services to wireless communication devices such as mobile terminals, mobile phones, smartphones etc. (often denoted by UE that is short for user equipment), have evolved during the last decade into systems that provide data communication services to very advanced devices. However, much of the communication that takes place in these systems is still in the form of more or less “traditional” telephone calls where a first user (often denoted A-subscriber) makes calls to a second user (B-subscriber) by dialing the telephone number of the B-subscriber. In other words, even if most UE's are in the form of advanced smart phones, basic telephone services are still used in the systems to a large extent.

Within the third generation partnership project, 3GPP, and other standardization forums, work is performed that aims at specifying a set of supplementary services used to enhance the basic services of UE's, such as smartphones and tablets. Supplementary services are services that can be configured in different ways, as selected by the user of the UE. As an example, the “call forwarding” supplementary service enhances the UE's basic voice call service, and the user can configure under what conditions incoming calls should be forwarded, and to which telephone number.

Definitions have been made of a basic user interface for supplementary services configuration based on dialing special numeric man-machine interface, MMI, codes, such as “*21*+123456789#” to activate unconditional forwarding of all incoming calls to the phone number+123456789. These MMI codes were originally defined in a circuit switched context, where the mobile terminals had only one way to configure supplementary services, defined as part of the radio protocol stack. However, in packet switched contexts with, e.g., the introduction of an internet protocol multimedia subsystem, IMS, and subsequently voice over long term evolution, VoLTE, 3GPP added a packet-switched option for supplementary services configuration, based on the extensible markup language, XML, configuration access protocol, XCAP, XML-over-HTTP (Hypertext Transfer Protocol) protocol. Moreover, 3GPP has also defined a way to send MMI codes to an IMS network in a session initiation protocol, SIP, INVITE message, complementary to the use of XCAP.

The SIP-based method for supplementary services configuration described above allows for activation, deactivation and configuration of supplementary services. However, it does not include any way for the UE to interrogate the present status of a supplementary service in a machine-readable fashion. As a consequence, the user of the UE will not be able to determine in a GUI what their currently selected supplementary services settings are. For example, is not possible for the user of the UE to determine to which number calls are currently being forwarded. This becomes especially problematic when a supplementary service has been configured by a network operator and the user is not allowed to change it. For example, an operator may want to lock the call forwarding service so that calls can only be forwarded to a particular number. Without the ability to interrogate the service, the user will not be able to determine to which number calls will be forwarded.

In contrast, the XCAP-based method for supplementary services configuration enables supplementary services interrogation, by returning over the XCAP protocol a description of the currently configured options for the service that is interrogated. However, XCAP has a number of disadvantages compared to SIP-based supplementary services configuration:

The SIP protocol is required by IMS terminals to perform the basic IMS registration, as well as for call control and other signalling. For this reason, all IMS implementations include a SIP software stack for the creation, parsing and transmission of SIP traffic. Since XCAP is based on the HTTP protocol, it requires a further software stack to similarly handle HTTP traffic. At least in some terminal types the inclusion of an HTTP stack may be an unnecessary overhead, increasing the cost of such a device. Moreover, XCAP cannot re-use the security mechanism used for IMS SIP traffic, based on IMS authentication and key agreement, AKA, authentication and internet protocol security, IPSec. Instead, solutions such as generic bootstrapping architecture, GBA, can be used, but this increases the size and complexity of the supporting software stack required by XCAP, further increasing device cost.

### SUMMARY

An object of the present disclosure is to overcome or at least mitigate at least some of the drawbacks related to supplementary services configuration status.

This object is achieved, in a first aspect, by a method performed by a UE. The UE is connected via a radio access network to a wireless communication system. The method comprises transmitting, to a node in the wireless communication system, a session initiation protocol, SIP, INVITE message that comprises a man-machine interface, MMI, code that defines an interrogation regarding a status of a supplementary service associated with the UE. The supplementary service may be, e.g., call forwarding, caller ID, call barring, call waiting etc. A SIP message that comprises the status of the supplementary service associated with the UE is then received from the node in the wireless communication system.

The status of the supplementary service is in a machine readable format, for example in any of a plain text format and an XML format.

In various embodiments, the reception of the SIP message may comprise reception of any of a SIP BYE message and a SIP 200 OK message, and the status of the supplementary service may be comprised in the body of the received message.

The transmission of the SIP INVITE message and the reception of the SIP message may in various embodiments, comprise transmission to and reception from an internet protocol multimedia subsystem, IMS, node, respectively.

In a second aspect there is provided a method performed by a node in a wireless communication system. The method comprises receiving, from a UE that is connected via a radio access network to the wireless communication system, a session initiation protocol, SIP, INVITE message that comprises a man-machine interface, MMI, code that defines an interrogation regarding a status of a supplementary service associated with the UE. The supplementary service may be, e.g., call forwarding, caller ID, call barring, call waiting etc. The status of a supplementary service associated with the UE is then retrieved.

A SIP message that comprises the status of the supplementary service associated with the UE is then transmitted to the UE. The status is in a machine readable format, for example in any of a plain text format and an XML format.

In various embodiments, the transmission of the SIP message may comprise transmission of any of a SIP BYE message and a SIP 200 OK message, and the status of the supplementary service may be comprised in the body of the transmitted message.

The retrieving of the status of a supplementary service associated with the UE may in various embodiments comprise receiving from a status database via a supplementary services settings server.

In other words, a SIP-based method for supplementary services configuration is extended by introducing a means for the IMS network to service supplementary services interrogation requests from a UE by responding to a SIP INVITE sent by the UE with a SIP message and including, e.g., in the SIP message body a machine-readable representation of the interrogated service's current configuration.

The terminal initiates the interrogation request by sending to the IMS network a SIP INVITE message in the same manner as if initiating a phone call, but using, instead of the remote party's phone number, an MMI code for supplementary service interrogation.

In response to this INVITE, the network retrieves the requested information detailing the status of the supplementary service and constructs a machine-readable representation of this information, such as XML text. The network node then sends this text back to the UE, e.g., in the body of a SIP message such as SIP BYE or SIP 200 OK.

In contrast to supplementary services configuration over XCAP, embodiments of these aspects provide supplementary services configuration that is simpler to transmit across an IMS network and that is easier to implement in a UE. Moreover, in contrast to existing SIP-based supplementary services configuration, embodiments of these aspects provide for machine-readable interrogation of the status of supplementary services. Prior art systems typically provide such status information in the form of a voice speaking out the requested information.

It is to be noted that herein, the expression “machine readable” may be interpreted in terms of contrasting to the prior art voice recordings or synthetically generated voices.

In a third aspect there is provided a UE that comprises radio frequency circuitry, a processor and a memory. The memory contains instructions executable by the processor whereby the UE is operative to transmit, to a node in the wireless communication system, a session initiation protocol, SIP, INVITE message that comprises a man-machine interface, MMI, code that defines an interrogation regarding a status of a supplementary service associated with the UE, and receive, from the node in the wireless communication system, a SIP message that comprises the status of the supplementary service associated with the UE, said status being in a machine readable format.

In a fourth aspect there is provided a node that comprises input/output circuitry, a processor and a memory. The memory contains instructions executable by the processor whereby the node is operative to receive, from a user equipment, UE, being connected via a radio access network to the wireless communication system, a session initiation protocol, SIP, INVITE message that comprises a man-machine interface, MMI, code that defines an interrogation regarding a status of a supplementary service associated with the UE, retrieve the status of a supplementary service associated with the UE, and transmit, to the UE, a SIP message that comprises the status of the supplementary service associated with the UE, said status being in a machine readable format.

In other aspects there are provided a respective computer program, comprising instructions which, when executed on at least one processor in a node or a UE, cause the node or UE to carry out the respective methods as summarized above in connection with the first and second aspects and the various embodiments of these aspects.

In other aspects there are provided a respective carrier comprising a computer program according to the summarized aspects above, wherein the respective carrier is one of an electronic signal, an optical signal, a radio signal and a computer readable storage medium.

These other aspects provide the same effects and advantages as summarized above in connection with the first aspect and the second aspect.

### BRIEF DESCRIPTION OF THE DRAWINGS

FIG. 1a schematically illustrates a wireless communication system,

FIG. 1b schematically illustrates parts of a wireless communication system,

FIG. 2a is a flow chart of a method in a UE,

FIG. 2b is a flow chart of a method in a node,

FIG. 2c is a flow chart of a method in a UE,

FIG. 2d is a flow chart of a method in a node,

FIG. 2e is a signaling diagram,

FIG. 2f is a flow chart of a method in a UE,

FIG. 2g is a flow chart of a method in a node,

FIG. 2h is a signaling diagram,

FIG. 3 schematically illustrates a UE,

FIG. 4 schematically illustrates a node,

FIG. 5 schematically illustrates a UE, and

FIG. 6 schematically illustrates a node.

### DETAILED DESCRIPTION

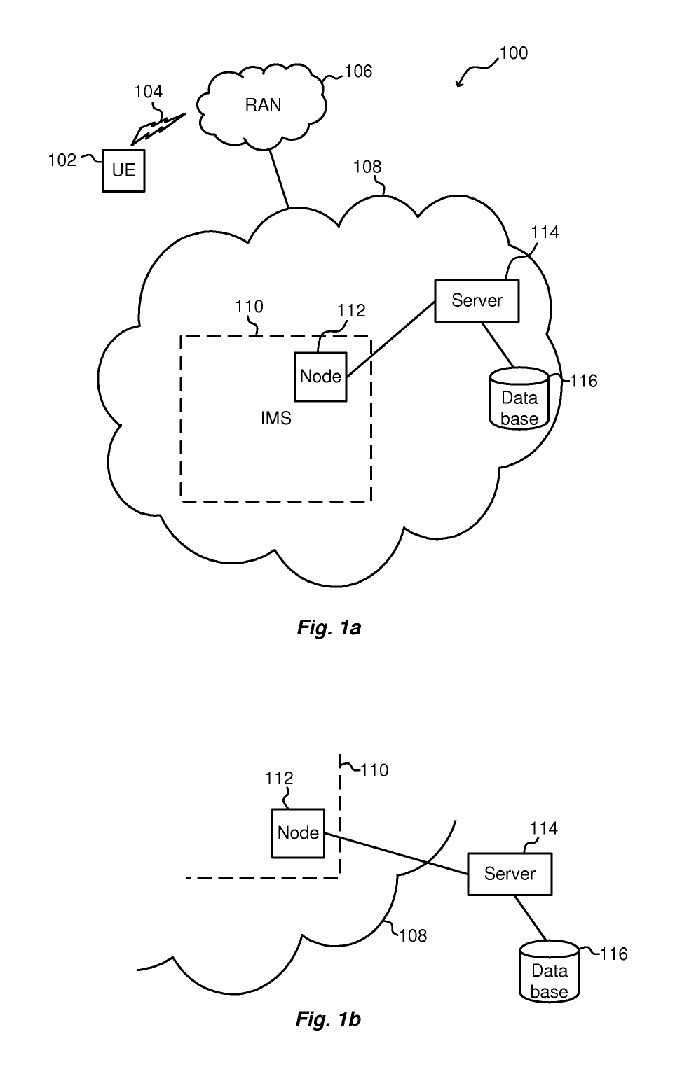

FIG. 1a illustrates, schematically in a block diagram form, a wireless communication system 100 in which embodiments herein may be implemented. The wireless communications system 100 may be any wireless communication system, such as a Universal Mobile Telecommunication System, UMTS, Wideband Code Division Multiple Access, WCDMA, network, a Global System for Mobile communication, GSM, CDMA2000 (where CDMA is an abbreviation of Code Division Multiple Access) or the like. The wireless communication system 100 may even be an evolution of any one of the aforementioned systems or a combination thereof.

The wireless communication system 100 may comprise a number of different nodes distributed in a radio access network, RAN, 106 and a core network 108. For the purpose of avoiding unnecessary cluttering of the drawings and the present description, only a few such nodes are illustrated, and only those nodes are illustrated that are involved in the realization of the different aspects of how to mitigate drawbacks of prior art solutions, as summarized above. That is, the skilled person will realize that the system 100 may comprise a large number of interacting entities (not shown in FIG. 1) and the skilled person will realize how these entities communicate in order to provide communication such as session initiation protocol, SIP, message communication between these entities.

A number of wireless communication devices may be operating in the wireless communication system 100. One such wireless communication device 102 is shown being in connection via a radio interface 104 with the RAN 106. The term wireless communication device may refer to a user equipment, UE, a subscriber unit, mobile phone, a cellular phone, a Personal Digital Assistant, PDA, equipped with radio communication capabilities, a smartphone, a laptop or personal computer, PC, equipped with an internal or external mobile broadband modem, a tablet PC with radio communication capabilities, a portable electronic radio communication device or the like. In the present disclosure, the term UE will be used.

The core network 108 comprises an internet protocol multimedia subsystem, IMS, 110 that comprises an IMS node 112. The IMS node 112 is connected to a supplementary services settings server, which may be in the form of an extensible markup language, XML, server 114. The server 114 is connected to a database 116. The database 116 may contain information that specifies details regarding supplementary services that are associated with the UE 102. For example, the database may contain information that specifies details of current status regarding call forwarding, caller ID, call barring and call waiting as configured by a user of the UE, e.g. by way of dialing specific MMI codes as described above.

As exemplified in FIG. 1a, the server 114 and the database 116 may be parts of the core network 108. However, as exemplified in FIG. 1b, the server 114 and the database 116 may be outside of the core network 108.

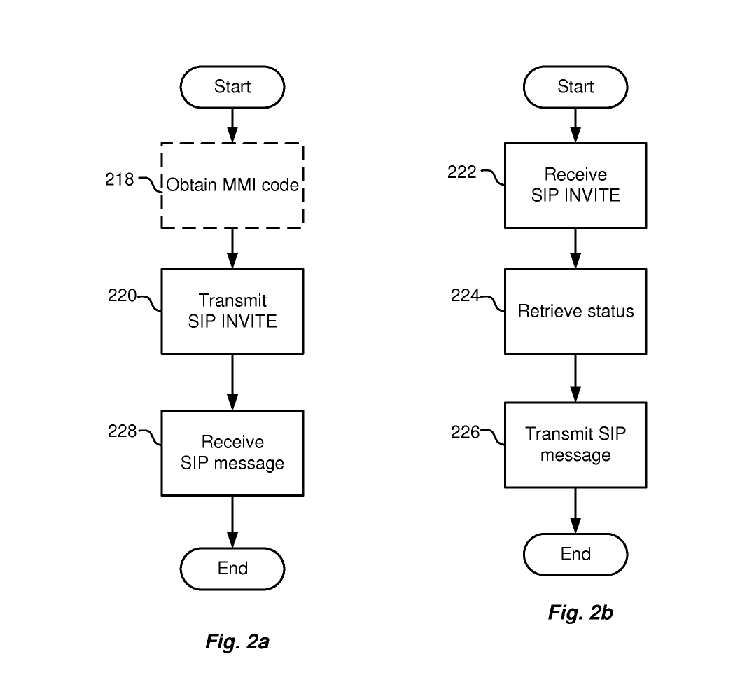

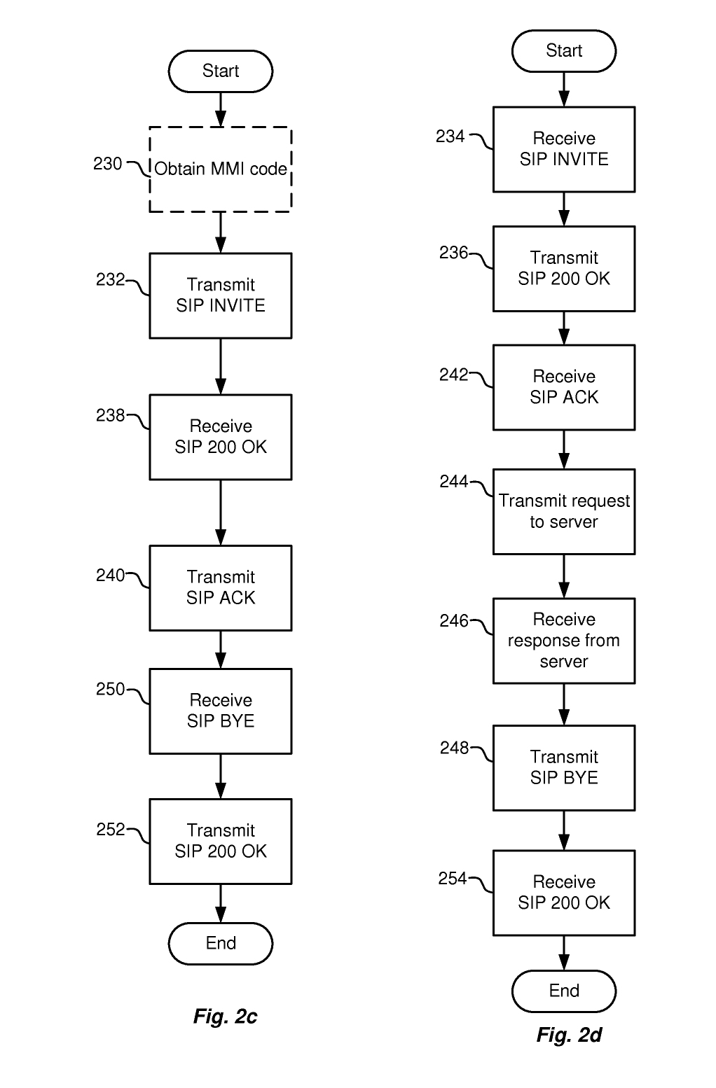

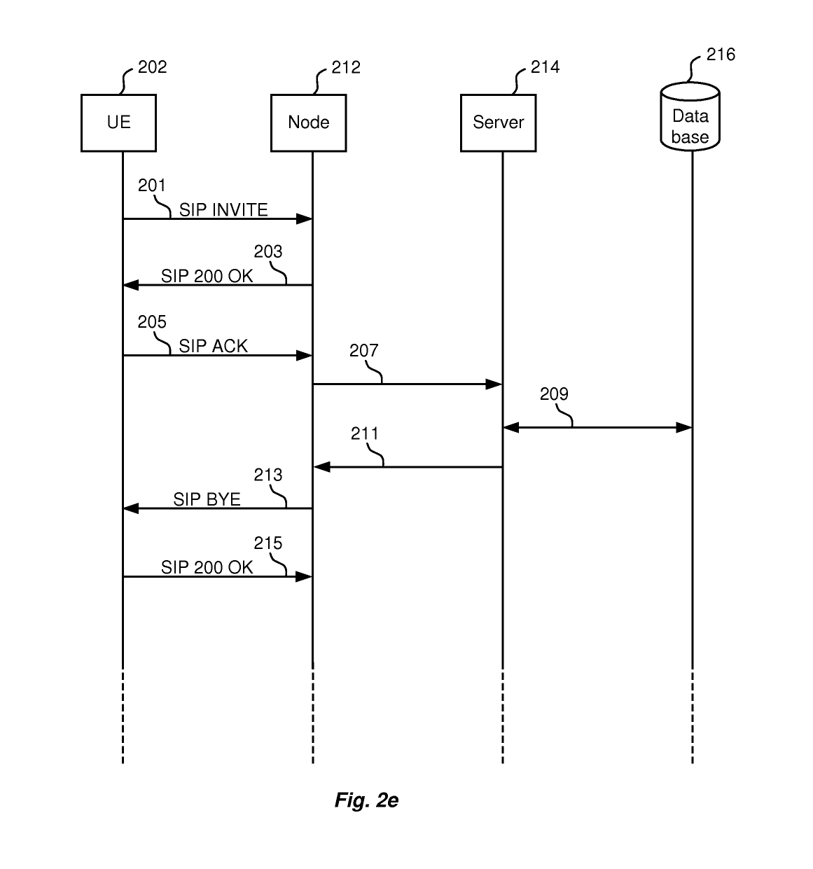

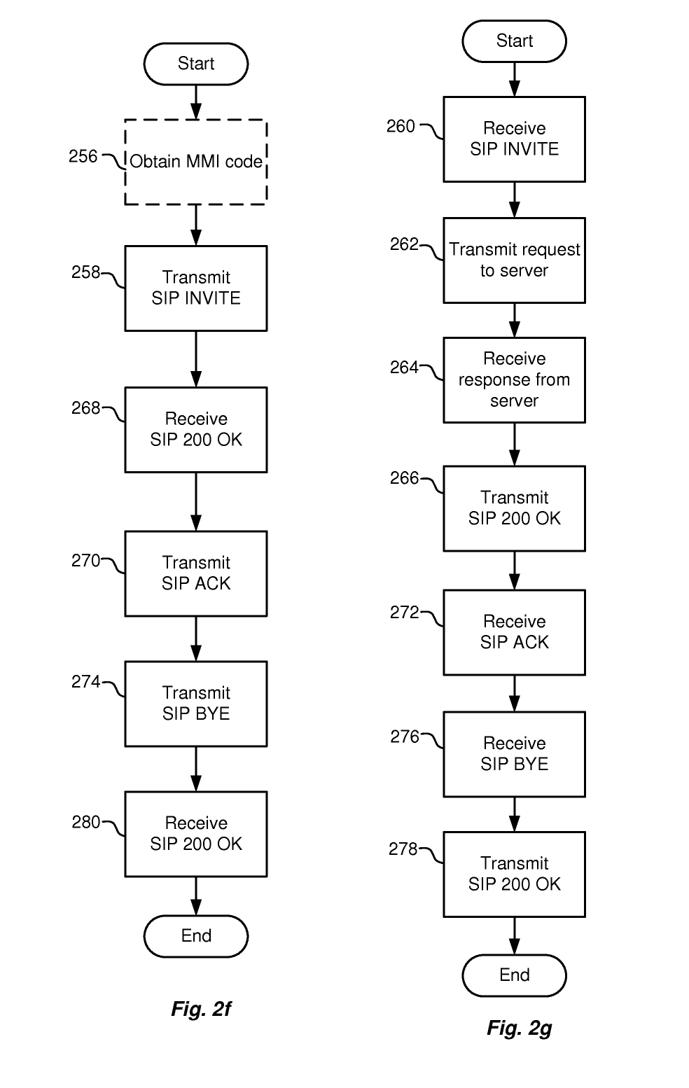

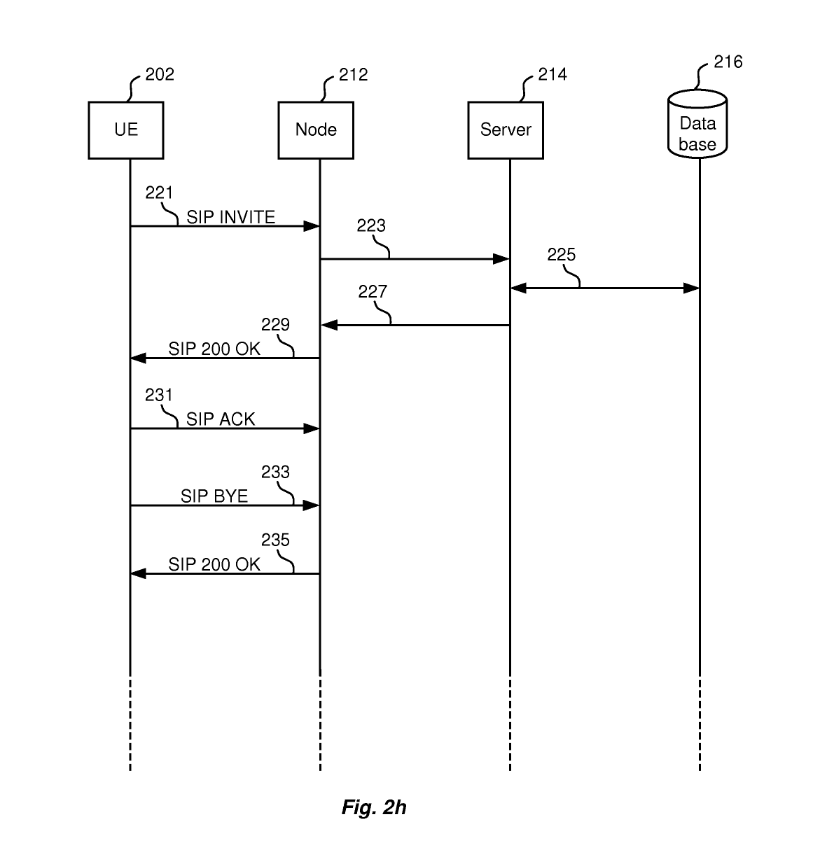

Turning now to the flow charts in FIG. 2a and FIG. 2b with continued reference to FIGS. 1a and 1b, methods performed in a UE and a node, such as the UE 102 and the node 112 in FIG. 1a and FIG. 1b, will be described. The FIGS. 2a-b contain a number of actions that involve transmission and reception of information between a UE and a node, such as the UE 102 and node 112 described above in connection with FIGS. 1a and 1b. The transmission of information between the UE and the node takes place via appropriate protocol stacks, from top layer application layers down to physical layers, implemented in and between the entities. However, all details regarding the realization of this layered communication are known to the skilled person and will consequently not be described in any detail here.

### Action 218

A MMI code that defines an interrogation regarding a status of a supplementary service associated with the UE is obtained. As the skilled person will realize, this action may involve obtaining user input via a keypad, touch screen etc. that is part of the UE.

### Action 220

A SIP INVITE message that comprises the MMI code that defines an interrogation regarding a status of a supplementary service associated with the UE is transmitted from the UE to the node.

### Action 222

The SIP INVITE message that comprises a MMI code that defines an interrogation regarding a status of a supplementary service associated with the UE is received by the node.

### Action 224

The status of a supplementary service associated with the UE is retrieved by the node. As will be exemplified below, the retrieval may be from a database via a server.

### Action 226

A SIP message that comprises the status of the supplementary service associated with the UE, said status being in a machine readable format, is transmitted from the node to the UE.

### Action 228

The SIP message that comprises the status of the supplementary service associated with the UE, said status being in a machine readable format, is received by the UE from the node.

The machine readable status may then be presented to a user of the UE in any suitable manner, e.g. displayed on a display, the details of which are outside the scope of the present disclosure.

Turning now to the flow charts in FIG. 2c and FIG. 2d and the signaling diagram in FIG. 2e, and with continued reference to FIGS. 1a and 1b, methods performed in a UE and a node, such as the UE 102 and the node 112 in FIG. 1a and FIG. 1b, will be described in some detail. The FIGS. 2c-e contain a number of actions that involve transmission and reception of information between a UE 202, a node 212, a supplementary services settings server 214 and a database 216. These entities may be a respective UE 102, node 112, server 114 and database 116 described above in connection with FIGS. 1a and 1b. The transmission of information between these entities takes place via appropriate protocol stacks, from top layer application layers down to physical layers, implemented in and between the entities. However, all details regarding the realization of this layered communication are known to the skilled person and will consequently not be described in any detail here.

### Action 230

A MMI code that defines an interrogation regarding a status of a supplementary service associated with the UE is obtained. As the skilled person will realize, this action may involve obtaining user input via a keypad, touch screen etc. that is part of the UE.

### Action 232

A SIP INVITE message 201 that comprises the MMI code that defines an interrogation regarding a status of a supplementary service associated with the UE is transmitted from the UE 202 to the node 212.

### Action 234

The SIP INVITE message 201 received from the UE 202, that comprises a MMI code that defines an interrogation regarding a status of a supplementary service associated with the UE 202 is received in the node 212.

In other words, the UE 202 sends a request in the form of the SIP INVITE message 201 to the node 212. The MMI code for interrogation of the supplementary service may be in a uniform resource identifier, URI, of the request.

### Action 236

The node 212 responds to the received SIP INVITE message 201 by transmitting a SIP 200 OK message 203 to the UE 202.

### Action 238

The UE 202 receives the SIP 200 OK message 203.

### Action 240

In response to the fact that the SIP 200 OK message 203 has been received, the UE 202 acknowledges receiving the SIP 200 OK message 203 by transmitting a SIP ACK message 205 to the node 212.

### Action 242

The node 212 receives the SIP ACK message 205 from the UE 202.

### Action 244

As a consequence of the reception of the SIP ACK message 205 from the UE 202, the node 212 initiates retrieval of the requested status of the supplementary service by transmitting, to the server 214, a request 207 for the status of the supplementary service.

### Action 246

The retrieval of the requested status of the supplementary service status continues with a reception, from the server 214 of a signal 211 comprising the status of the requested supplementary service. As illustrated in FIG. 2c, the server 214 and the database 216 interacts via signals 209 in order to obtain the status of the requested supplementary service. For example, assuming that the status of the requested supplementary service is stored in the database 216 in a legacy binary format, and the server 214 is an XML server, the XML server 214 may perform the function of converting status information into XML format.

An example of an XML representation of the status of the requested supplementary service is provided below. In this example, the supplementary service in question is call forwarding (<communication-diversion>), which automatically forwards calls to another number. The example specifies that when the UE's user is occupied in another call (<condition-busy>) or does not answer (<condition-no-answer>) within 60 seconds (<timer>60</timer>), the call will be forwarded (<forward-to>) to another number (<target>+123456789</target>).

```
<communication-diversion>
  <condition-busy>
    <forward-to>
      <target>+123456789</target>
    </forward-to>
  </condition-busy>
  <condition-no-answer>
    <forward-to>
      <target>+123456789</target>
      <timer>60</timer>
    </forward-to>
  </condition-no-answer>
</communication-diversion>
```

### Action 248

A SIP BYE message 213 is transmitted from the node 212 to the UE 202. The SIP BYE message 213 comprises the status of the supplementary service associated with the UE 202, said status being in a machine readable format. As exemplified above, the status may be in XML format and the status may be contained in the body of the SIP BYE message 213.

### Action 250

The SIP BYE message 213, being in a machine readable format, that comprises the status of the supplementary service associated with the UE is received in the UE 202 from the node 212.

### Action 252

In response to the fact that the SIP BYE message 213 has been received, the UE 202 transmits a SIP 200 OK message 215 to the node 212.

### Action 254

The node 212 receives the SIP 200 OK message 215.

Turning now to the flow charts in FIG. 2f and FIG. 2g and the signaling diagram in FIG. 2h, and with continued reference to FIGS. 1a and 1b, methods performed in a UE and a node, such as the UE 102 and the node 112 in FIG. 1a and FIG. 1b, will be described in some detail. As for the embodiments described above in connection with FIGS. 2c-e, FIGS. 2f-h contain a number of actions that involve transmission and reception of information between a UE 202, a node 212, a supplementary services settings server 214 and a database 216. These entities may be a respective UE 102, node 112, server 114 and database 116 described above in connection with FIGS. 1a and 1b. The transmission of information between these entities takes place via appropriate protocol stacks, from top layer application layers down to physical layers, implemented in and between the entities. However, all details regarding the realization of this layered communication are known to the skilled person and will consequently not be described in any detail here.

### Action 256

A MMI code that defines an interrogation regarding a status of a supplementary service associated with the UE is obtained. As the skilled person will realize, this action may involve obtaining user input via a keypad, touch screen etc. that is part of the UE.

### Action 258

A SIP INVITE message 221 that comprises the MMI code that defines an interrogation regarding a status of a supplementary service associated with the UE is transmitted from the UE 202 to the node 212.

### Action 260

The SIP INVITE message 221 received from the UE 202, that comprises a MMI code that defines an interrogation regarding a status of a supplementary service associated with the UE 202 is received in the node 212.

### Action 262

As a consequence of the reception of the SIP INVITE message 221 from the UE 202, the node 212 initiates retrieval of the requested status of the supplementary service by transmitting, to the server 214, a request 223 for the status of the supplementary service.

### Action 264

The retrieval of the requested status of the supplementary service status continues with a reception, from the server 214 of a signal 227 comprising the status of the requested supplementary service. As illustrated in FIG. 2h, the server 214 and the database 216 interacts via signals 225 in order to obtain the status of the requested supplementary service. For example, assuming that the status of the requested supplementary service is stored in the database 216 in a legacy binary format, and the server 214 is an XML server, the XML server 214 may perform the function of converting status information into XML format, an example of which is described above in connection with action 246 in FIG. 2d.

### Action 266

A SIP 200 OK message 229 is transmitted from the node 212 to the UE 202. The SIP 200 OK message 229 comprises the status of the supplementary service associated with the UE 202, said status being in a machine readable format. As exemplified above, the status may be in XML format and the status may be contained in the body of the SIP 200 OK message 229.

### Action 268

The SIP 200 OK message 229, being in a machine readable format, that comprises the status of the supplementary service associated with the UE is received in the UE 202 from the node 212.

### Action 270

In response to the fact that the SIP 200 OK message 229 has been received, the UE 202 acknowledges receiving the SIP 200 OK message 229 by transmitting a SIP ACK message 231 to the node 212.

### Action 272

The node 212 receives the SIP ACK message 231 from the UE 202.

### Action 274

The UE then begins a termination of the methods by transmitting a SIP BYE message 233 to the UE 202.

### Action 276

The node 214 receives the SIP BYE message 233 from the UE 202.

### Action 278

In response to the SIP BYE message 233, the node 212 transmits a SIP OK message 235 to the UE 202.

### Action 280

The UE 202 receives the SIP 200 OK message 235 from the node 212, whereby the methods end.

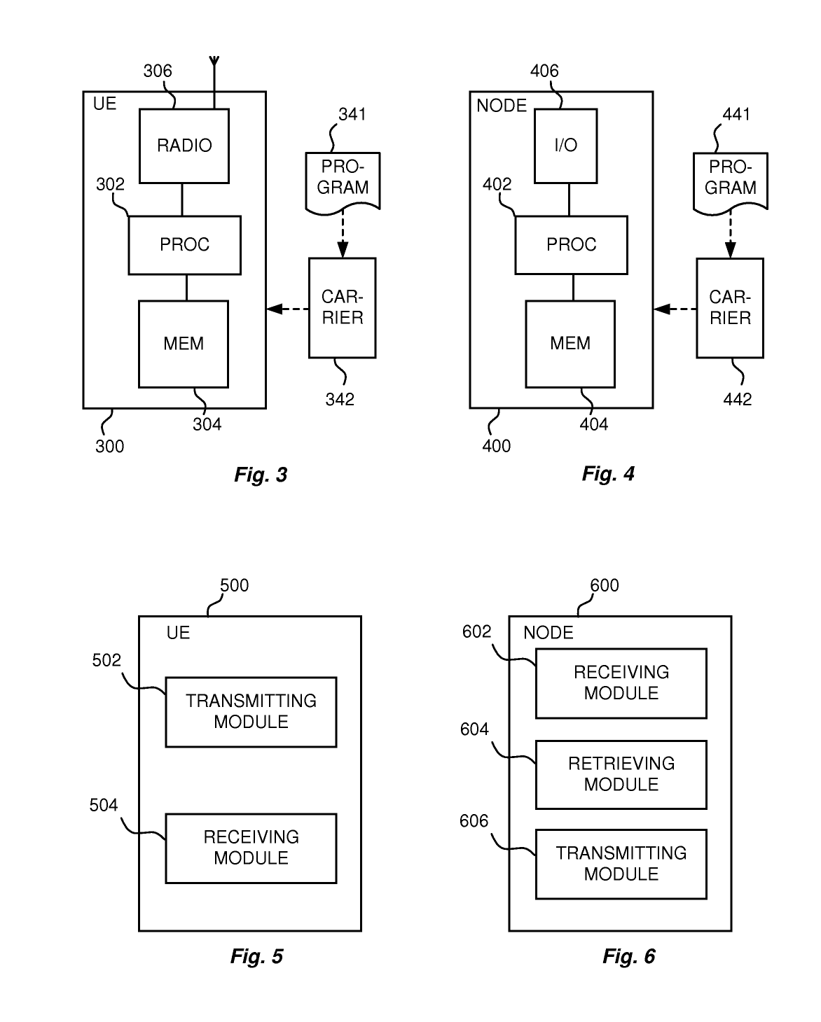

Turning now to FIG. 3, a UE 300 such as the UE 102 and the UE 202 in FIG. 1 and FIG. 2c, respectively, will be described in some more detail. The UE 300 comprises radio frequency circuitry 306, a processor 302 and a memory 304. The memory contains instructions executable by the processor 302 whereby the UE 300 is operative to:
transmit, to a node in the wireless communication system, a session initiation protocol, SIP, INVITE message that comprises a man-machine interface, MMI, code that defines an interrogation regarding a status of a supplementary service associated with the UE, and
receive, from the node in the wireless communication system, a SIP message that comprises the status of the supplementary service associated with the UE, said status being in a machine readable format.

In some embodiments, the UE 300 is operative such that the reception of the SIP message comprises reception of any of a SIP BYE message and a SIP 200 OK message, and operative such that the status of the supplementary service is comprised in the body of the received message.

In some embodiments, the UE 300 is operative such that the status of the supplementary service associated with the UE is in any of a plain text format and an extensible markup language, XML, format. In some embodiments, the UE 300 is operative such that the transmission of the SIP INVITE message and the reception of the SIP message comprises transmission to and reception from an internet protocol multimedia subsystem, IMS, node, respectively.

In some embodiments, the UE 300 is operative such that the supplementary service is any of call forwarding, caller ID, call barring, and call waiting.

The instructions that are executable by the processor 302 may be software in the form of a computer program 341. The computer program 341 may be contained in or by a carrier 342, which may provide the computer program 341 to the memory 304 and processor 302. The carrier 342 may be in any suitable form including an electronic signal, an optical signal, a radio signal or a computer readable storage medium.

Turning now to FIG. 4, a node 400 such as the node 112 and the node 212 in FIG. 1 and FIG. 2c, respectively, will be described in some more detail. The node 400 comprises input/output circuitry 406, a processor 402 and a memory 404. The memory contains instructions executable by the processor 402 whereby the node 400 is operative to:
receive, from a user equipment, UE, being connected via a radio access network to the wireless communication system, a session initiation protocol, SIP, INVITE message that comprises a man-machine interface, MMI, code that defines an interrogation regarding a status of a supplementary service associated with the UE,
retrieve the status of a supplementary service associated with the UE, and
transmit, to the UE, a SIP message that comprises the status of the supplementary service associated with the UE, said status being in a machine readable format.

In some embodiments, the node 400 is operative such that the transmission of the SIP message comprises transmission of any of a SIP BYE message and a SIP 200 OK message, and operative such that the status of the supplementary service is comprised in the body of the transmitted message.

In some embodiments, the node 400 is operative such that the status of the supplementary service associated with the UE is in any of a plain text format and an extensible markup language, XML, format.

In some embodiments, the node 400 is operative such that the retrieving of the status of a supplementary service associated with the UE comprises receiving from a status database via a supplementary services settings server.

In some embodiments, the node 400 is operative such that the supplementary service is any of call forwarding, caller ID, call barring, and call waiting.

The instructions that are executable by the processor 402 may be software in the form of a computer program 441. The computer program 441 may be contained in or by a carrier 442, which may provide the computer program 441 to the memory 404 and processor 402. The carrier 442 may be in any suitable form including an electronic signal, an optical signal, a radio signal or a computer readable storage medium.

Turning now to FIG. 5, a UE 500 such as the UE 102 and the UE 202 in FIG. 1 and FIG. 2c, respectively, will be described in some more detail. The UE 500 comprises:
a transmitting module 502 configured to transmit, to a node in a wireless communication system, a session initiation protocol, SIP, INVITE message that comprises a man-machine interface, MMI, code that defines an interrogation regarding a status of a supplementary service associated with the UE, and
a receiving module 504 configured to receive, from the node in the wireless communication system, a SIP message that comprises the status of the supplementary service associated with the UE, said status being in a machine readable format.

The UE 500 may comprise further modules that are configured to perform in a similar manner as, e.g., the UE 300 described above in connection with FIG. 3.

Turning now to FIG. 6, a node 600 such as the node 112 and the node 212 in FIG. 1 and FIG. 2c, respectively, will be described in some more detail. The node 600 comprises:
a receiving module 602 configured to receive, from a user equipment, UE, being connected via a radio access network to the wireless communication system, a session initiation protocol, SIP, INVITE message that comprises a man-machine interface, MMI, code that defines an interrogation regarding a status of a supplementary service associated with the UE,
a retrieving module 604 configured to retrieve the status of a supplementary service associated with the UE, and
a transmitting module 606 configured to transmit, to the UE, a SIP message that comprises the status of the supplementary service associated with the UE, said status being in a machine readable format.

The node 600 may comprise further modules that are configured to perform in a similar manner as, e.g., the node 400 described above in connection with FIG. 4.

As used herein, the term “processing module” may refer to a processing circuit, a processing unit, a processor, an Application Specific integrated Circuit (ASIC), a Field-Programmable Gate Array (FPGA) or the like. As an example, a processor, an ASIC, an FPGA or the like may comprise one or more processor kernels. In some examples, the processing module may be embodied by a software module or hardware module. Any such module may be a determining means, estimating means, capturing means, associating means, comparing means, identification means, selecting means, receiving means, transmitting means or the like as disclosed herein. As an example, the expression “means” may be a module, such as a determining module, selecting module, etc.

As used herein, the expression “configured to” may mean that a processing circuit is configured to, or adapted to, by means of software configuration and/or hardware configuration, perform one or more of the actions described herein.

As used herein, the term “memory” may refer to a hard disk, a magnetic storage medium, a portable computer diskette or disc, flash memory, random access memory (RAM) or the like. Furthermore, the term “memory” may refer to an internal register memory of a processor or the like.

As used herein, the term “computer readable medium” may be a Universal Serial Bus (USB) memory, a DVD-disc, a Blu-ray disc, a software module that is received as a stream of data, a Flash memory, a hard drive, a memory card, such as a MemoryStick, a Multimedia Card (MMC), etc.

As used herein, the term “computer readable code units” may be text of a computer program, parts of or an entire binary file representing a computer program in a compiled format or anything there between.

As used herein, the terms “number”, “value” may be any kind of digit, such as binary, real, imaginary or rational number or the like. Moreover, “number”, “value” may be one or more characters, such as a letter or a string of letters. “number”, “value” may also be represented by a bit string.

As used herein, the expression “in some embodiments” has been used to indicate that the features of the embodiment described may be combined with any other embodiment disclosed herein.

Even though embodiments of the various aspects have been described, many different alterations, modifications and the like thereof will become apparent for those skilled in the art. The described embodiments are therefore not intended to limit the scope of the present disclosure.

1: A method, performed by a user equipment, UE, said UE being connected in a radio access network in a wireless communication system, the method comprising:
transmitting, to a node in the wireless communication system, a session initiation protocol, SIP, INVITE message that comprises a man-machine interface, MMI, code that defines an interrogation regarding a status of a supplementary service associated with the UE; and
receiving, from the node in the wireless communication system, a SIP message that comprises the status of the supplementary service associated with the UE, said status being in a machine readable format.

2: The method of claim 1, wherein the reception of the SIP message comprises reception of any of a SIP BYE message and a SIP 200 OK message, and wherein the status of the supplementary service is comprised in the body of the received message.

3: The method of claim 1, wherein the status of the supplementary service associated with the UE is in any of a plain text format and an extensible markup language, XML, format.

4: The method of claim 1, wherein the transmission of the SIP INVITE message and the reception of the SIP message comprises transmission to and reception from an internet protocol multimedia subsystem, IMS, node, respectively.

5: The method of claim 1, wherein the supplementary service is any of:
call forwarding,
caller ID,
call barring, and
call waiting.

6: A method, performed by a node in a wireless communication system, the method comprising:
receiving, from a user equipment, UE, being connected in a radio access network in the wireless communication system, a session initiation protocol, SIP, INVITE message that comprises a man-machine interface, MMI, code that defines an interrogation regarding a status of a supplementary service associated with the UE;
retrieving the status of a supplementary service associated with the UE; and
transmitting, to the UE, a SIP message that comprises the status of the supplementary service associated with the UE, said status being in a machine readable format.

7: The method of claim 6, wherein the transmission of the SIP message comprises transmission of any of a SIP BYE message and a SIP 200 OK message, and wherein the status of the supplementary service is comprised in the body of the transmitted message.

8: The method of claim 6, wherein the status of the supplementary service associated with the UE is in any of a plain text format and an extensible markup language, XML, format.

9: The method of claim 6, wherein the retrieving of the status of a supplementary service associated with the UE comprises receiving from a status database via a supplementary services settings server.

10: The method of claim 6, wherein the supplementary service is any of:
call forwarding,
caller ID,
call barring, and
call waiting.

11: A user equipment, UE, comprising radio frequency circuitry, and a memory, said memory containing instructions executable by said processor whereby said UE is operative to:
transmit, to a node in a wireless communication system, a session initiation protocol, SIP, INVITE message that comprises a man-machine interface, MMI, code that defines an interrogation regarding a status of a supplementary service associated with the UE; and
receive, from the node in the wireless communication system, a SIP message that comprises the status of the supplementary service associated with the UE, said status being in a machine readable format.

12: A node, comprising input/output circuitry, a processor and a memory, said memory containing instructions executable by said processor whereby said node is operative, in a wireless communication system, to:
receive, from a user equipment, UE, being connected via a radio access network to the wireless communication system, a session initiation protocol, SIP, INVITE message that comprises a man-machine interface, MMI, code that defines an interrogation regarding a status of a supplementary service associated with the UE;
retrieve the status of a supplementary service associated with the UE; and
transmit, to the UE, a SIP message that comprises the status of the supplementary service associated with the UE, said status being in a machine readable format.

13: A nontransitory computer readable storage medium comprising a computer program, comprising instructions which, when executed on at least one processor in a UE that is connected in a radio access network in a wireless communication system, cause the UE to carry out a method comprising:
transmitting, to a node in the wireless communication system, a session initiation protocol, SIP, INVITE message that comprises a man-machine interface, MMI, code that defines an interrogation regarding a status of a supplementary service associated with the UE, and
receiving, from the node in the wireless communication system, a SIP message that comprises the status of the supplementary service associated with the UE, said status being in a machine readable format.

14: A nontransitory computer readable storage medium comprising a computer program, comprising instructions which, when executed on at least one processor in a node in a wireless communication system, cause the node to carry out a method comprising:
receiving, from a user equipment, UE, being connected in a radio access network in the wireless communication system, a session initiation protocol, SIP, INVITE message that comprises a man-machine interface, MMI, code that defines an interrogation regarding a status of a supplementary service associated with the UE,
retrieving the status of a supplementary service associated with the UE, and
transmitting, to the UE, a SIP message that comprises the status of the supplementary service associated with the UE, said status being in a machine readable format.

15. (canceled)
